(19) United States
(12) Patent Application Publication
(10) Pub. No.: US 2026/0108832 A1
(43) Pub. Date: Apr. 23, 2026

(54) Preparation Method for Antimicrobial Air Filtration Material

(71) Applicant: Jun'nan LIU, Beijing (CN)

(72) Inventor: Jun'nan LIU, Beijing (CN)

(21) Appl. No.: 18/919,863

(22) Filed: Oct. 18, 2024

(51) Int. Cl. B01D 39/08

(52) U.S. Cl. CPC B01D 39/083; B01D 2239/0442; B01D 2239/0492; B01D 2239/0622; B01D 2239/10

(57) ABSTRACT

The invention discloses a preparation method for an antimicrobial air filtration material, comprising the following steps: opening and carding low-melting-point fibers and 2D fibers, then conveying the fibers to a lapping machine to form a fiber web; subjecting the fiber web to thermal pressing and shaping to form a filtration base cloth; introducing the filtration base cloth onto a spraying shaft of a melt-blown line; mixing polypropylene particles and a silver ion antimicrobial agent, and putting the mixture into a heating bin for melt blowing, so that the melt-blown polypropylene fibers adhere to an outer surface of the filtration base cloth to form a PP melt-blown layer, resulting in an air filtration cloth; spraying an antimicrobial viscose solution at high pressure on the PP melt-blown layer; and then performing drying and shaping, trimming and rolling to obtain the antimicrobial air filtration material.

### BACKGROUND OF THE INVENTION

### 1. Technical Field

The invention belongs to the technical field of air filtration materials, and particularly relates to a preparation method for an antimicrobial air filtration material.

### 2. Description of Related Art

With the progress of the times, rapid economic development has intensified environmental pollution, with airborne dust, chemicals, and harmful microorganisms adversely affecting people's health. However, the demand for environmental quality is increasing, especially in densely populated areas where there are higher requirements for air purification. To achieve a higher level of cleanliness in the environment, the commonly used method is filtration. Air filtration materials can effectively intercept particulate matter, bacteria, viruses, and other microorganisms present in the air.

Air filtration materials are widely used in air conditioning, ventilation and purification systems, air purifiers, and vehicle air conditioning filter elements. Currently, air filtration materials primarily remove particulate matter and gaseous pollutants from the air. Air filters made from melt-blown fibers capture particulate matter or aerosol pollutants, while activated carbon or other materials are used to adsorb additional pollutants in the air. However, after a period of time intercepting dust and aerosol particles from the air, air filters accumulate a significant amount of dust on the surface of the filter screen and within their structure, which can easily lead to the proliferation of microorganisms such as bacteria, viruses, and molds. If not addressed promptly, this can result in severe secondary pollution.

Many researchers are attempting to develop more efficient air filtration materials.

Patent CN114130123A discloses an antimicrobial and antimildew air purification material, comprising a filtering layer, a transition layer, and a functional layer. The filtering layer is formed by a mixed stack of support fibers, strength fibers, and microfibers. The support fibers are polyester fibers, accounting for 10%-20% of the total, containing 10-20% of organic antimicrobial agents. The strength fibers are ABS plastic fibers with a diameter of 0.5-1 mm, accounting for 30-40% of the total, and containing 5-10% of molecular sieves, 3-10% of zinc oxide, and 4-12% of copper oxide. The microfibers are polypropylene fibers with a diameter of 0.1-2 μm, accounting for 40-60% of the total. The functional layer is a honeycomb structure filled with functional particles, which are composed of aluminum oxide molecular sieves loaded with manganese oxide and zinc oxide, with a manganese oxide content of 1-3% and a zinc oxide content of 2-5%. However, the preparation process involves the mixing and laminating of multiple materials, resulting in high process complexity, and the compatibility between different materials may affect overall performance, with long-term effectiveness and durability yet to be validated.

Patent CN113430662A discloses an antimicrobial, antimildew and antiviral melt-blown filter material and a preparation method thereof. The preparation method comprises the following steps: S1, preparing a melt-blown polypropylene masterbatch containing copper, silver, and zinc ion antimicrobial agents; S2, during the melt-blown spinning process of the polypropylene masterbatch, spraying mixed particles of stearic acid and zinc oxide onto a fiber surface of a resulting melt-blown polypropylene nonwoven fabric under the action of melt-blown jets, producing a melt-blown polypropylene nonwoven fabric, the molar ratio of zinc oxide to stearic acid being (0.2-1):1; S3, conducting water electret treatment on the melt-blown polypropylene nonwoven fabric to obtain the antimicrobial, antimildew and antiviral melt-blown filter material. However, the zinc oxide particles do not adhere well to the surface of the nonwoven fabric and can easily detach after high-pressure water cleaning, leading to a noticeable decline in antimicrobial performance and a reduced lifespan. Additionally, the water electret treatment is very expensive, resulting in a higher cost of the filter material.

### BRIEF SUMMARY OF THE INVENTION

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

The purpose of the invention is to provide a preparation method for an antimicrobial air filtration material to address technical problems in the prior art, such as limited material performance, weakened performance after cleaning, and short lifespan.

To solve the above technical problems, the invention provides the following technical scheme.

A preparation method for an antimicrobial air filtration material provided by the invention comprises the following steps:
S1, feeding low-melting-point fibers into a first cotton-blending opener for opening, adding 2D fibers into a second cotton-blending opener for opening, then conveying the fibers to a cotton-blending box for uniform mixing to obtain mixed fibers, and conveying the mixed fibers to a carding machine for carding;
S2, conveying the carded mixed fibers to a lapping machine to form a fiber web, the fiber web consisting of 4-6 layers and having a gram weight of 0.03-0.06 kg/m²;
S3, conveying the fiber web to a hot-pressing roller for thermal pressing and shaping to form a filtration base cloth, a roller surface temperature of the hot-pressing roller being 200-300° C.;
S4, introducing the filtration base cloth onto a spraying shaft of a melt-blown line in an inverted C-shaped form;
S5, mixing polypropylene particles and a silver ion antimicrobial agent in a mass ratio of 100:(1-5), putting the mixture into a heating bin, heating to 180-230° C. for melt blowing, so that the melt-blown polypropylene fibers adhere to an outer surface of the filtration base cloth to form a PP melt-blown layer, and conducting drafting, netting, reinforcing or self-bonding to obtain an air filtration cloth with a dual-layer structure consisting of a fluffy upper layer and a dense lower layer;
S6, spraying an antimicrobial viscose solution at high pressure on the PP melt-blown layer of the air filtration cloth, a spraying amount of the antimicrobial viscose solution being 1%-2% of the gram weight of the air filtration cloth; and
S7, conveying the air filtration cloth to a drying device for drying and shaping, trimming and rolling to obtain the antimicrobial air filtration material.

Preferably, the low-melting-point fibers are polyethylene terephthalate (PET) with a melting point of 110-150° C., such as LMF fibers produced by Huvis Sichuan. Low-melting-point polyester fibers have a lower melting temperature than ordinary low-melting-point fibers, and can be melted and bonded with other fibers at a lower temperature.

The 2D fibers are synthetic fibers with polyester as the raw material, processed through specific techniques, with a melting point of 240-260° C., such as 2De*64 mm fibers produced by Huvis Sichuan or Sinopec Yizheng Chemical Fibre Co., Ltd. in Jiangsu.

An original fiber length of the low-melting-point fibers and the 2D fibers is 65±5 mm, which is reduced to 10-30 mm after being heated and shaped by the hot-pressing roller.

Preferably, the PP melt-blown layer has a fiber length of 5-15 mm, a diameter of 0.5-10 μm, and a gram weight of 0.02-0.06 kg/m².

Preferably, the antimicrobial viscose solution is prepared by uniformly mixing inorganic silver ion antimicrobial agent (such as LD904 by Nanjing Tiansland Biotechnology Co., Ltd.), water and carboxylated styrene-butadiene latex according to a mass ratio of (1.0-2.5):(6-10):1, and the preferred mass ratio is 1:8:1.

Preferably, the temperature for drying and shaping is 100-150° C.

The antimicrobial air filtration material prepared by the preparation method of the invention is applied to air filtration devices such as air conditioning, ventilation and purification systems, air purifiers, and vehicle air conditioning filter elements.

Compared with the prior art, the invention has the following advantages.

The antimicrobial air filtration material of the invention is a dual-layer fiber web formed by the intercrossing of microfibers. One layer is a rigid support structure that provides excellent support for the filtration material, reducing the resistance of the filtration cloth and enhancing filtration efficiency. The other layer is a melt-blown filtration layer containing antimicrobial agents. The PP melt-blown filtration layer has numerous voids and a fluffy structure, with small fiber diameters and a large specific surface area, featuring a unique capillary structure that increases the number of fibers per unit area and the surface area. This effectively prevents harmful particles from entering while maintaining high breathability and oil absorption, making it easier to integrate antimicrobial components. Additionally, the air filtration material of the invention possesses antimicrobial and antiviral functions, as well as excellent durability and washability. The filtration cloth can withstand repeated washing while maintaining high filtration efficiency and antimicrobial effectiveness, retaining 90.1% of its antimicrobial rate even after 12 washes, with only a 6% reduction in filtration efficiency.

### BRIEF DESCRIPTION OF THE SEVERAL VIEWS OF THE DRAWINGS

FIG. 1 is a microscopic view of long fibers formed after heating and shaping of a fiber web.

FIG. 2 is a microscopic view of short fibers of a PP melt-blown layer.

FIG. 3 is a microscopic view of an air filtration cloth with a dual-layer structure consisting of a fluffy upper layer and a dense lower layer.

### DETAILED DESCRIPTION

In describing the preferred embodiments, specific terminology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

The raw materials used in Embodiments 1˜4 and Comparative examples 1-2 are all commercially available products:
low-melting-point fibers: LMF 4de*64 mm fibers produced by Huvis Sichuan;
2D fibers: 2De*64 mm fibers produced by Huvis Sichuan or Sinopec Yizheng Chemical Fibre Co., Ltd. in Jiangsu;
inorganic silver ion antimicrobial agent: LD904 by Nanjing Tiansland Biotechnology Co., Ltd.;
carboxylated styrene-butadiene latex: produced by Mingzhou Chemical Co., Ltd., with the brand code MZ-01852.

### Embodiment 1

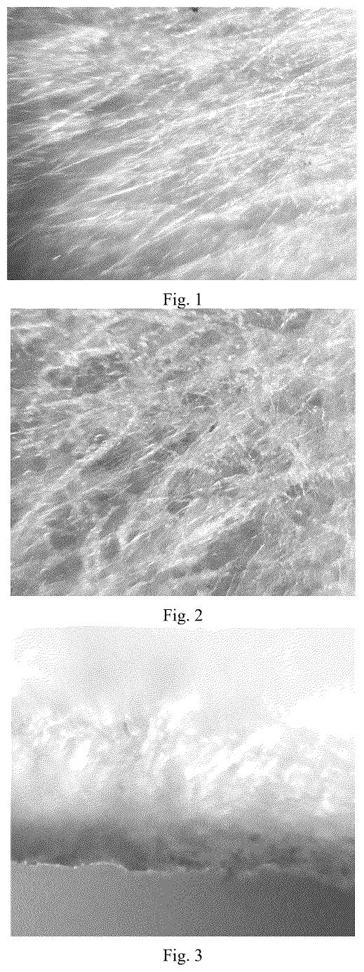

A preparation method for an antimicrobial air filtration material comprises the following steps:
S1, feeding low-melting-point fibers into a first cotton-blending opener for opening, adding 2D fibers into a second cotton-blending opener for opening, then conveying the fibers to a cotton-blending box for uniform mixing to obtain mixed fibers, and conveying the mixed fibers to a carding machine for carding, an original fiber length of the low-melting-point fibers and the 2D fibers being 65 mm;
S2, conveying the carded mixed fibers to a lapping machine to form a fiber web, the fiber web consisting of 6 layers and having a gram weight of 0.06 kg/m²;
S3, conveying the fiber web to a hot-pressing roller for thermal pressing and shaping to form a filtration base cloth made of interwoven and bonded fibers, a roller surface temperature of the hot-pressing roller being 280° C., and the fiber length being 10-30 mm after being heated and shaped by the hot-pressing roller (as shown in FIG. 1);
S4, introducing the filtration base cloth onto a spraying shaft of a melt-blown line in an inverted C-shaped form;
S5, mixing polypropylene particles and a silver ion antimicrobial agent in a mass ratio of 100:5, putting the mixture into a heating bin, heating to 225° C. for melt blowing, so that the melt-blown polypropylene fibers adhere to an outer surface of the filtration base cloth to form a PP melt-blown layer featuring a molten structure composed of short fiber filaments (as shown in FIG. 2), the polypropylene fibers having a diameter of 0.5-10 μm and a fiber length of 5-15 mm and the PP melt-blown layer having a gram weight of 0.04 kg/m², and conducting drafting, netting, self-bonding to obtain an air filtration cloth with a dual-layer structure consisting of a fluffy upper layer and a dense lower layer (as shown in FIG. 3);
S6, spraying an antimicrobial viscose solution at high pressure on the PP melt-blown layer of the air filtration cloth, a spraying amount of the antimicrobial viscose solution being 2% of the gram weight of the air filtration cloth, and the antimicrobial viscose solution being prepared by uniformly mixing inorganic silver ion antimicrobial agent, water and carboxylated styrene-butadiene latex according to a mass ratio of 1:8:1; and
S7, conveying the air filtration cloth to a drying device for drying and shaping at 100-150° C., trimming and rolling to obtain the antimicrobial air filtration material.

The production process of Embodiment 2 is the same as that of Embodiment 1, except that in step S5 of Embodiment 2, the mass ratio of polypropylene particles to silver ion antimicrobial agent is 100:3.

The production process of Embodiment 3 is the same as that of Embodiment 1, except that in step S5 of Embodiment 3, the mass ratio of polypropylene particles to silver ion antimicrobial agent is 100:1.

### Embodiment 4

A preparation method for an antimicrobial air filtration material comprises the following steps:
S1, feeding low-melting-point fibers into a first cotton-blending opener for opening, adding 2D fibers into a second cotton-blending opener for opening, then conveying the fibers to a cotton-blending box for uniform mixing to obtain mixed fibers, and conveying the mixed fibers to a carding machine for carding, a fiber length of the low-melting-point fibers and the 2D fibers being 65 mm;
S2, conveying the carded mixed fibers to a lapping machine to form a fiber web, the fiber web consisting of 4 layers and having a gram weight of 0.04 kg/m²;
S3, conveying the fiber web to a hot-pressing roller for thermal pressing and shaping to form a filtration base cloth, a roller surface temperature of the hot-pressing roller being 220° C., and the fiber length being 18-30 mm after being heated and shaped by the hot-pressing roller;
S4, introducing the filtration base cloth onto a spraying shaft of a melt-blown line in an inverted C-shaped form;
S5, mixing polypropylene particles and a silver ion antimicrobial agent in a mass ratio of 100:4, putting the mixture into a heating bin, heating to 185° C. for melt blowing, so that the melt-blown polypropylene fibers adhere to an outer surface of the filtration base cloth to form a PP melt-blown layer featuring a molten structure composed of short fiber filaments, the polypropylene fibers having a diameter of 0.5-10 μm and a fiber length of 5-15 mm and the PP melt-blown layer having a gram weight of 0.05 kg/m², and conducting drafting, netting, self-bonding to obtain an air filtration cloth with a dual-layer structure consisting of a fluffy upper layer and a dense lower layer;
S6, spraying an antimicrobial viscose solution at high pressure on the PP melt-blown layer of the air filtration cloth, a spraying amount of the antimicrobial viscose solution being 1.5% of the gram weight of the air filtration cloth, and the antimicrobial viscose solution being prepared by uniformly mixing inorganic silver ion antimicrobial agent, water and carboxylated styrene-butadiene latex according to a mass ratio of 2:10:1; and
S7, conveying the air filtration cloth to a drying device for drying and shaping at 100-150° C., trimming and rolling to obtain the antimicrobial air filtration material.

The production process of Embodiment 5 is the same as that of Embodiment 2, except that in step S6 of Embodiment 5, the spraying amount of the antimicrobial viscose solution is 1% of the gram weight of the air filtration cloth, and the antimicrobial viscose solution is prepared by uniformly mixing inorganic silver ion antimicrobial agent, water and carboxylated styrene-butadiene latex according to a mass ratio of 2:7:1.

Comparative example 1 is a comparative example of Embodiment 4, differing in that step S1 uses only low-melting point fibers in Comparative example 1, the roller surface temperature of the hot-pressing roller in step S3 is set to 155° C., and the fiber length is 35-50 mm after being heated and shaped by the hot-pressing roller.

Comparative example 2 is Embodiment 4 from patent CN113430662A.

### Test Experiment Examples

The antimicrobial air filtration materials obtained from Embodiments 1-5 and Comparative examples 1-2 were tested. The PM2.5 filtration efficiency (%) and resistance were measured in accordance with GB/T6165-2005 “Test method of the performance of high efficiency particulate air filter-Efficiency and resistance”, with a wind speed of 2.2 m/s for the PM2.5 filtration efficiency test, using sodium chloride aerosol as the PM2.5 dust source. The antimicrobial rate was assessed based on GB/T20944.3-2008 “Textiles-Evaluation for antibacterial activity-Part 3: Shake flask method”, with Escherichia coli (ATCC25922) as the test organism. The cleaning procedure involved rinsing a filter screen with an 8 kg pressure water source from a metal guard for at least 3 minutes, followed by drying in a hot air oven at 40° C.

TABLE 1
Test results for Embodiments 1-4 and Comparative documents 1-2

| | | | PM2.5 | |
|---|---|---|---|---|
| | Number of | Antimicrobial | filtration | Resistance |
| | washes | rate | efficiency (%) | (Pa) |
| Embodiment 1 | 1 | 98.3 | 80.5 | 41.7 |
| | 4 | 96.4 | 80.1 | 42.3 |
| | 8 | 92.7 | 76.1 | 43.1 |
| | 12 | 90.1 | 75.4 | 43.8 |
| Embodiment 2 | 1 | 97.2 | 81.1 | 42.5 |
| | 4 | 95.5 | 80.0 | 41.6 |
| | 8 | 91.1 | 75.8 | 43.2 |
| | 12 | 88.5 | 75.5 | 40.2 |
| Embodiment 3 | 1 | 96.9 | 80.7 | 42.0 |
| | 4 | 95.1 | 79.5 | 43.5 |
| | 8 | 90.2 | 76.5 | 43.2 |
| | 12 | 87.6 | 76.0 | 41.5 |
| Embodiment 4 | 1 | 98.5 | 82.2 | 42.6 |
| | 4 | 96.7 | 81.6 | 43.1 |
| | 8 | 93.1 | 78.5 | 43.8 |
| | 12 | 90.8 | 76.5 | 44.2 |
| Embodiment 5 | 1 | 97.9 | 80.5 | 40.2 |
| | 4 | 95.7 | 80.4 | 42.1 |
| | 8 | 92.7 | 77.8 | 43.9 |
| | 12 | 90.2 | 76.3 | 44.4 |
| Comparative | 1 | 98.1 | 77.6 | 42.9 |
| example 1 | 4 | 95.7 | 62.3 | 48.2 |
| | 8 | 92.6 | 50.4 | 57.4 |
| | 12 | 89.6 | 41.6 | 66.8 |
| Comparative | 1 | 99.1 | 85.4 | 43.8 |
| example 2 | 4 | 88.3 | 75.3 | 44.2 |
| | 8 | 80.9 | 54.9 | 45.8 |
| | 12 | 73.4 | 42.7 | 53.7 |

As shown in Table 1, the antimicrobial air filtration material of the invention is produced through a one-time processing method with a dual-layer structure. It utilizes low-melting-point fibers combined with 2D fibers to create a dense and firm filtration interception layer, complemented by a melt-blown layer coated with polypropylene fibers that forms a filtration structure with one side compact and the other side fluffy. This structure facilitates the subsequent processing and shaping of air filter elements. Additionally, the polyester fiber layer does not experience issues such as fiber shedding or breakage. It not only provides excellent filtration performance against fine particulate matter (such as PM2.5) in the air and significant antimicrobial effects but also exhibits outstanding durability and washability, maintaining high filtration efficiency and antimicrobial effectiveness even after repeated washes, and retaining 90.1% of its antimicrobial rate even after 12 washes, with only a 6% reduction in filtration efficiency.

In Comparative example 1, the use of only low-melting-point fibers results in insufficient support from the rigid support structure layer, which cannot withstand the hydraulic washing during multiple cleans, making it prone to collapse and causing fiber blockage in the pores. This leads to a sharp increase in resistance and ultimately a significant decrease in PM2.5 filtration efficiency.

Comparative document 2 (i.e., patent CN113430662A) describes a polypropylene melt-blown process that is a basic processing technique in the industry, where zinc oxide particles do not adhere well to the surface of the non-woven fabric and can easily detach after high-pressure water cleaning, leading to a noticeable decline in antimicrobial performance and a reduced lifespan.

The technical means disclosed in the scheme of the present invention are not limited to the technical means disclosed in the above embodiments, but also include the technical scheme composed of any combination of the above technical features. It should be pointed out that for those skilled in the art, several improvements and embellishments can be made without departing from the principle of the present invention, and these improvements and embellishments are also regarded as the protection scope of the present invention.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

1. A preparation method for an antimicrobial air filtration material, comprising the following steps:
S1, feeding low-melting-point fibers into a first cotton-blending opener for opening, adding 2D fibers into a second cotton-blending opener for opening, then conveying the fibers to a cotton-blending box for uniform mixing to obtain mixed fibers, and conveying the mixed fibers to a carding machine for carding:
S2, conveying the carded mixed fibers to a lapping machine to form a fiber web, the fiber web consisting of 4-6 layers and having a gram weight of 0.03-0.06 kg/m²;
S3, conveying the fiber web to a hot-pressing roller for thermal pressing and shaping to form a filtration base cloth, a roller surface temperature of the hot-pressing roller being 200-300° C.;
S4, introducing the filtration base cloth onto a spraying shaft of a melt-blown line in an inverted C-shaped form;
S5, mixing polypropylene particles and a silver ion antimicrobial agent in a mass ratio of 100:(1-5), putting the mixture into a heating bin, heating to 180-230° C. for melt blowing, so that the melt-blown polypropylene fibers adhere to an outer surface of the filtration base cloth to form a PP melt-blown layer, and conducting drafting, netting, reinforcing or self-bonding to obtain an air filtration cloth with a dual-layer structure consisting of a fluffy upper layer and a dense lower layer;
S6, spraying an antimicrobial viscose solution at high pressure on the PP melt-blown layer of the air filtration cloth, a spraying amount of the antimicrobial viscose solution being 1%-2% of the gram weight of the air filtration cloth; and
S7, conveying the air filtration cloth to a drying device for drying and shaping, trimming and rolling to obtain the antimicrobial air filtration material.

2. The preparation method for an antimicrobial air filtration material according to claim 1, wherein the low-melting-point fibers are polyethylene terephthalate with a melting point of 110-150° C., and the 2D fibers are synthetic fibers with polyester as the raw material, processed through specific techniques, with a melting point of 240-260° C.

3. The preparation method for an antimicrobial air filtration material according to claim 1, wherein an original fiber length of the low-melting-point fibers and the 2D fibers is 65±5 mm, which is reduced to 10-30 mm after being heated and shaped by the hot-pressing roller.

4. The preparation method for an antimicrobial air filtration material according to claim 1, wherein the PP melt-blown layer has a fiber length of 5-15 mm, a diameter of 0.5-10 μm, and a gram weight of 0.02-0.06 kg/m².

5. The preparation method for an antimicrobial air filtration material according to claim 1, wherein the antimicrobial viscose solution is prepared by uniformly mixing inorganic silver ion antimicrobial agent, water and carboxylated styrene-butadiene latex according to a mass ratio of (1.0-2.5):(6-10):1.

6. The preparation method for an antimicrobial air filtration material according to claim 5, wherein the antimicrobial viscose solution is prepared by uniformly mixing inorganic silver ion antimicrobial agent, water and carboxylated styrene-butadiene latex according to a mass ratio of 1:8:1.

7. The preparation method for an antimicrobial air filtration material according to claim 1, wherein the temperature for drying and shaping is 100-150° C.

8. An antimicrobial air filtration material obtained by the preparation method according to claim 1.

9. An application of the antimicrobial air filtration material according to claim 8, wherein the antimicrobial air filtration material is applied to air filtration devices such as air conditioning, ventilation and purification systems, air purifiers, and vehicle air conditioning filter elements.
